(19) United States
(12) Patent Application Publication
(10) Pub. No.: US 2026/0356018 A1
(43) Pub. Date: Nov. 12, 2026

(54) METHOD FOR PRODUCING FLAT FUEL CELL COMPONENTS, IN PARTICULAR BIPOLAR PLATES, AND FUEL CELL COMPONENT PRODUCED ACCORDING TO THE METHOD

(71) Applicant: E.K. LEONHARDT, Hochdorf (DE)

(72) Inventors: Wolfgang LEONHARDT, Hochdorf (DE); Marcel LEONHARDT, Reutlingen (DE); Alexander OPPENLÄNDER, Kirchheim unter Teck (DE)

(21) Appl. No.: 19/135,076

(22) PCT Filed: Dec. 6, 2023
(86) PCT No.: PCT/EP2023/084547

§ 371 Date: Jun. 3, 2025

(30) Foreign Application Priority Data
Dec. 8, 2022 (DE) 10 2022 132 735.3

(51) Int. Cl. B29C 45/00; B29C 45/14; B29C 45/40; B29C 45/73; B29K 71/00; B29K 105/00; B29K 507/04; B29L 31/34; H01M 8/0213; H01M 8/0221; H01M 8/0226

(52) U.S. Cl. CPC B29C 45/0001; B29C 45/14; B29C 45/40; B29C 45/7312; H01M 8/0213; H01M 8/0221; H01M 8/0226; B29K 2071/00; B29K 2105/251; B29K 2507/04; B29K 2995/0005; B29K 2995/0013; B29K 2995/0097; B29L 2031/3468

(57) ABSTRACT

The invention relates to a method for producing flat fuel cell components (6), in particular bipolar plates, from thermoplastic material with an additional component that has good electrical and thermal conductivity, wherein the flat fuel cell component is produced by means of injection molding using an injection molding device (1) which has at least one injection unit (2) and at least one mold unit (3) with a wall surrounding a respective cavity. Efficient production of flat fuel cell components is achieved in that the melted thermoplastic material with the additional component is filled as melt mass by means of the at least one injection unit (2) under pressure into the hollow space of the respective cavity (31) of the at least one mold unit (3), said hollow space corresponding unchanged to the geometry of the fuel cell component, and the heat transfer via the wall (30) is adapted to the thermal conductivity and thermal capacity and filling speed of the melt mass in such a manner that the respective cavity (31) is completely filled with this as molding mass (5) before the temperature of the melt mass falls below its melting temperature.

The invention relates to a method for producing flat fuel cell components, in particular bipolar plates, from thermoplastic material with an additional component that has good electrical and thermal conductivity, wherein the flat fuel cell component is produced by means of injection molding using an injection molding device which has at least one injection unit and at least one mold unit with a wall surrounding a respective cavity.

Furthermore, the invention relates to a flat fuel cell component produced by the method and to a device for producing such a flat fuel cell component.

A method of this type, as well as a flat fuel cell component, in particular a bipolar plate, produced from a modified thermoplastic material, are disclosed in WO 94/25995 A1. In this known method, polyethersulfone (PES) is specified as the preferred thermoplastic material, with the further advantage that this material can be processed by injection molding or extrusion, making it possible to join individual components of a fuel cell made of PES to one another by plastics welding or bonding. In order to achieve the electrical conductivity required for the fuel cell, the thermoplastic material is modified by incorporating conductive particles such as conductive carbon black, graphite or the like, with the conductive particles being added to the melted polymer. No further details are provided regarding the injection molding process per se.

Since such flat fuel cell components, such as bipolar plates or electrode plates in particular, have very thin walls despite their relatively large planar extent (e.g. in the order of a DIN A4 format) and generally have a thickness of less than 1 mm, their production by injection molding is difficult, in particular due to the rapid cooling in the mold unit during the injection process. As a measure to prevent excessively rapid cooling before the thin, large-area cavity of the mold unit is completely filled, it is common practice to apply heat to the cavity wall during injection of the melt mass, followed by a subsequent pressing process. In this way, rapid heat dissipation from the melt mass during the injection molding process can be avoided and complete filling of the cavity with the melt mass can be achieved, wherein it can also be taken into account that the melt mass modified with the conductive particles for use in the fuel cell has a high thermal conductivity, which also leads to rapid heat dissipation. Post-pressing requires additional work steps and a correspondingly complex design of the injection molding device. The subsequent cooling and solidification of the melt mass or molding mass before ejection of the molded part in the form of the flat fuel cell component further extends the injection molding cycle. In addition, the heating device and, in the case of variothermal design, a cooling device, are energy-intensive.

US 2004/0 115 505 A1 discloses a method for producing flat fuel cell components by means of an injection molding device, wherein an adjustable mold part is used for pressing onto the injection molding material that has already been filled into the cavity of the mold or is currently in the filling state. Electrically conductive filler material accounts for 60 to 95 wt. % of the molding mass. The adjustable mold part and its operation require additional effort.

Further injection molding devices for flat molded pieces, in which adjustable parts of the mold are also used for the molding process, are disclosed by JP 2006-327 051 A and JP 2009-226 641 A.

The object of the present invention is to provide a method for producing flat fuel cell components, in particular bipolar plates, which results in high-quality flat fuel cell components with efficient production, and also to provide corresponding fuel cell components.

This object is achieved in the method having the features of claim 1 and for flat fuel components having the features of claim 5.

In the method, it is provided according to the invention that the melted thermoplastic material with the additional component is filled as melt mass by means of the at least one injection unit under pressure into the hollow space of the respective cavity of the at least one mold unit, said hollow space corresponding unchanged to the geometry of the fuel cell component, and the heat transfer via the wall is adapted to the thermal conductivity and thermal capacity and filling speed of the melt mass in such a manner that the respective cavity is completely filled with this as molding mass before the temperature of the melt mass falls below its melting temperature.

Flat fuel components according to the invention are those which are produced by means of the named method and in particular those which possess sufficient inherent rigidity for the respective application in a fuel cell.

Due to the parameters of the injection molding device and the injection molding process, which are coordinated with one another during the injection molding process, including the state and properties of the injected melt mass, wherein the heat dissipation is so low in coordination with the injected melt mass that it reliably fills the cavity before it solidifies as a molding mass, it is possible to carry out the injection process and the molding of the flat fuel cell component efficiently with the least possible energy consumption and in the shortest possible time. The wall around the cavity is exposed to a temperature precisely tailored to the injection molding process and can then cool down to below the solidification temperature in a correspondingly short time until demolding. This significantly shortens the injection cycle while minimizing energy consumption, enabling efficient production of flat fuel cell components. For example, the wall of the respective cavity can be constructed or insulated with a plastics material with a significantly lower thermal conductivity (unit W/(k·m)) than that of the melt mass, using a correspondingly high temperature stability, so that too rapid dissipation of heat from the melt mass is avoided, i.e. before the melt mass fills the entire volume of the cavity. A metal wall construction with easily controllable or adjustable tempering elements for rapid heat supply and heat dissipation is also suitable, wherein a heat-insulating cladding of the wall for temperature control around the cavity is also advantageous for efficient process control.

To carry out the method, an injection molding device is provided with at least one injection unit for supplying a thermoplastic raw material with an electrically conductive additional component, in particular comprising graphite particles, and with at least one mold unit which has a nozzle-side mold portion assigned to an injection nozzle arrangement and an ejector-side mold portion assigned to an ejector side. The nozzle-side and the ejector-side mold portions face one another in a parting plane by means of a respective parting surface. The at least one mold unit comprises, in a mold part receptacle, a part of a respective mold part with a mold insert and a mold core, wherein a cavity which can be opened in the parting plane and closed during an injection process is formed in the mold insert, which cavity is connected to the injection unit via a feed unit with a hot runner system or cold runner system in order to inject the melted raw material as a melt mass into its cavity. The geometry of the hollow space of the respective cavity with the inner surface of the mold insert surrounding it is adapted unchanged to the geometry of the fuel component to be produced during the molding process until the at least one mold unit is opened. A post-pressing device that would change the geometry of the cavity during the molding process is not present.

A structure of the flat fuel cell component or bipolar plate which is advantageous for the functioning of the fuel cell is advantageously obtained by adding graphite and optionally additionally carbon black (at most 5 or 10 or 25 wt. % or at most 5 or 10 or 25 vol. % of the additional component) to the thermoplastic material as an electrically conductive additional component in a mass ratio greater than 5%, greater than 20% or greater than 30%, preferably greater than 50%, for example between 5% and 90% or 95%, in particular between 30% and 70% or 87%, of the conductive additional component to the total mass or the total volume of a raw material fed to the injection unit. Other additives can also be considered as electrically conductive additional components.

Further advantageous measures for carrying out the injection molding process efficiently include the thermoplastic material for the matrix being a matrix material with a free π-electron system, in particular PEEK material, and using graphite exclusively as the conductive additional component. In this embodiment, the invention is based on the consideration that the graphite in the matrix polymer of the molding mass connects conductively via the π-electron system without the conductive carbon black particles conventionally added for the conductive connection being required. Avoiding conductive carbon black allows for a reduction in the fill level with the additional component and contributes to the efficient execution of the injection molding process. As a result of avoiding post-pressing, the orientation of the graphite particles that occurs during the injection process can be used as a preferred direction to achieve good conductive properties of the produced flat fuel cell component.

A further advantageous design feature of the flat fuel component or bipolar plate results from the fact that the flat fuel cell component is produced with a thickness (d) perpendicular to its surface in plan view of, for example, at most 5 mm, in particular of at most 2 mm, at most 1 mm or at most 0.5 mm or 0.2 mm, while possessing sufficient inherent rigidity for use in a fuel cell.

Further advantageous measures for the production process and the function of the flat fuel cell component are that the graphite particles have an average size D₅₀ in the range of 5 μm to 50 μm or 100 μm and/or an aspect ratio (thickness to smallest dimension perpendicular to the thickness direction) of less than 5, in particular less than 1 or less than 0.5.

An advantageous production of the flat fuel cell component or bipolar plate is further achieved in that the fuel component is provided with at least one connection element, fastening element, line element and/or sealing element by molding and/or injection molding in the injection molding process. These measures can also substantially improve the production of the fuel cell as a whole and also of a fuel cell stack, while also enabling flexible adaptation to different operating conditions.

For an easily controllable injection molding process for the efficient production of flat fuel cell components, such as bipolar plates, further advantageous embodiments of the injection molding device consist in that tempering means are arranged between the mold insert and the mold core in the nozzle-side and/or the ejector-side mold portion, and in particular in that the tempering means comprise heating means and/or cooling means, and for example in that the heating means can be heated by means of current heat via electrical conduction means, inductively or by means of a heat transfer fluid guided through channels and/or in that the cooling means can be operated by means of a cooling fluid guided through channels or is provided with an electrically operated cooling device, and/or in that at least the mold insert is made of a material with good thermal conductivity, in particular metal or ceramic, and at least the mold part comprising the mold insert and the mold core is enclosed by heat-insulating parts.

The invention is explained in more detail below by means of examples with reference to the drawings, in which:

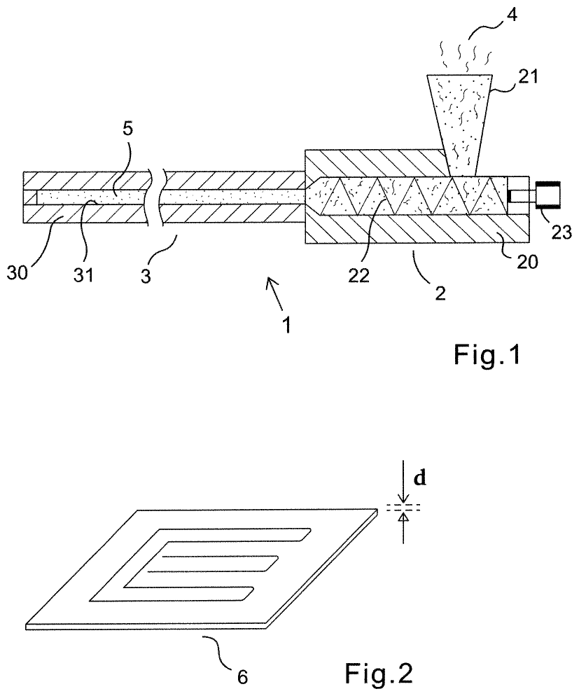

FIG. 1 is an injection molding device for producing flat fuel cell components, such as bipolar plates, in a schematic sectional view,

FIG. 2 is an embodiment of a flat fuel cell component in a schematic perspective view, and

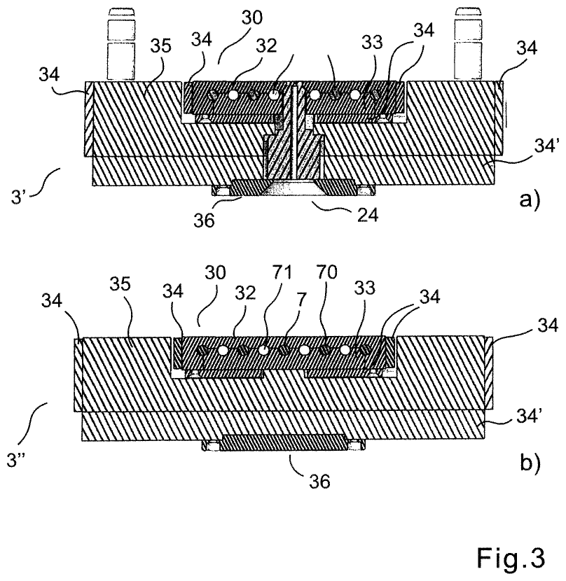

FIG. 3 is, in partial images a) and b), parts of a mold of the injection molding device in cross section.

FIG. 1 schematically shows, as an embodiment, an injection molding device 1 with an injection unit 2 and a mold unit 3 connected thereto in a schematic longitudinal section.

The injection unit 2 has a housing 20 with a funnel-shaped filling part 21 and a conveyor unit 22 with a conveyor screw and a drive unit 23.

The mold unit 3 comprises a mold part with a cavity 31 configured to correspond to the flat component to be produced, which cavity is surrounded by a wall 30. For removing the component obtained by the injection molding process, in this case the flat fuel cell component 6 (see FIG. 2), namely a bipolar plate, the mold unit 3 is provided with an opening device (not shown in detail) and a removal or ejection device.

The injection molding device 1 may also comprise multiple injection units 2 and/or mold units 3. The at least one mold unit is designed for injection with direct sprue or for injection with a manifold system (cold and/or hot runner system).

The injection molding device 1 advantageously has a mechanical venting system (not shown) or a vacuum venting system for the mold unit(s). Furthermore, it can be designed advantageously as a two- or multi-component mold with which a sealing system made of suitable polymer material can be circumferentially injected.

To carry out the injection molding process, appropriately prepared raw material 4 made of thermoplastic material and additional components, such as in this case in particular graphite and optionally also carbon black, is introduced into the filling part 21 and fed therefrom to the conveyor unit 22 with the conveyor screw. The raw material 4 is subjected to thermal energy above the melting point by means of a heating device arranged in the conveyor unit 22 and brought to the required temperature of the formed melt mass, which is then filled into the cavity 31 of the mold unit 3 at a predetermined injection pressure via a correspondingly designed sprue on the outlet side of the conveyor unit 22 until the cavity 31 is completely filled with the molding mass 5 then contained therein, corresponding to the flat component to be produced, in this case the flat fuel cell component 6.

The additional component(s) introduced into the raw material 4 to modify the thermoplastic material, in particular in the form of graphite and optionally carbon black, serves to achieve the electrical conductivity required to operate the fuel cell or a fuel cell stack and also to achieve good thermal conductivity in order to dissipate heat generated in the fuel cell. Depending on the requirements, the mass fraction or volume fraction of the additional component(s) in the mass fraction or, if applicable, of the raw material for the production of the flat fuel cell component 6 is more than 5%, more than 20%, more than 30% or even more than 40% and lies in the range between 5% and 95%, 20% and 90%, between 30% and 80% or between 40% and 80%, wherein the mass fraction or volume fraction can be suitably varied or adapted depending on the thermoplastic material and the required electrical conductivity during operation of the fuel cell as well as depending on the geometric structure of the flat fuel cell component 6.

FIG. 3 shows, also as an embodiment, in partial images a) and b), two parts of the mold unit 3 of the injection molding device 1, namely a nozzle-side mold portion 3′ designed for connection to the injection unit 2 and an ejector-side mold portion 3″, which together enclose the cavity 31 required for molding the flat fuel cell component, forming the wall 30. The wall 30 of the cavity 31 is formed by means of a mold insert 32, which is composed of a first part located in the nozzle-side mold portion 3′ and a second part arranged in the ejector-side mold portion 3″. The first and second parts of the mold insert 32 are in turn applied to a respective mold core 33 and the mold insert 32 and the mold core 33 as a unit are enclosed by respective insulating parts 34 on the outer side of this unit facing away from the cavity 31 in order to prevent heat dissipation from the unit consisting of the mold insert 32 and the mold core 33 as far as possible and to specifically temper the cavity with the injected melt mass or molding mass so that the melt mass maintains the temperature required to completely fill the cavity 31 during the injection process and to achieve the best possible temperature control of the cavity 31 with the injected melt mass.

The unit comprising the two parts of the mold insert 32 and the mold core 33 form a mold part of the mold unit 3, which is arranged in a mold part receptacle 35, which in turn is composed of two parts, one part of which is arranged in the nozzle-side mold portion 3′ and the other part in the ejector-side mold portion 3″. The molded part receptacle 35 is also insulated on its outer side by means of insulating parts 34 or 34′ in order to avoid heat dissipation as far as possible. For precise positioning, the mold part receptacle 35 has a centering part 36 on its outer side, which is parallel to the planar extent of the cavity 31.

In the illustrated embodiment of the mold unit 3, a feed unit 24 with a hot runner system for injecting the melt mass into the cavity 31 is located in the nozzle-side mold portion 3′ connected to the injection unit 2.

The nozzle-side mold portion in this case has guide pins that protrude from a surface of the nozzle-side mold portion 3′ lying in the parting plane of the mold unit 3 and interact precisely with guide receptacles (not shown) arranged in the corresponding plane of the ejector-side mold portion 3″ in order to close the mold part 3 in a guided manner and, following the molding process, to open it in a guided manner and eject the molded flat fuel cell component.

In order to specifically temper the cavity 31 during the molding process, tempering means 7 are arranged between the respective mold insert 32 and the mold core 33 in both the nozzle-side mold portion 3′ and the ejector-side mold portion 3″. The tempering means 7 comprise heating means 70 and may also comprise cooling means 71 for rapid, targeted cooling of the molding mass. The heating means 70 are designed, for example, as electrical heating lines through which current flows or as inductively actuated heating elements or as heating channels through which a heat transfer fluid (liquid or gaseous medium) flows. The cooling means 71 are designed as cooling channels or embedded tubes through which a cooling fluid flows, or as electrically operated cooling means. The parts of the mold insert 32 are advantageously made of a metal with good thermal conductivity, e.g., tool steel, or another material with good thermal conductivity, such as a ceramic. The mold core 33 can also be made of a metal, or alternatively of a temperature-resistant plastics material or, for example, a ceramic. Together with the insulation surrounding the unit consisting of the mold insert 32 and the mold core 33 by means of the insulating parts 34, an easily controllable, quickly responding temperature control is achieved in coordination with the injection process.

As an advantageous measure, the invention further provides for using a thermoplastic material as the melt mass or molding mass, to which graphite is preferably added as the sole additional component as electrically highly conductive particles. The thermoplastic polymer material serves as the matrix material of the flat fuel cell component to be produced and advantageously consists of a matrix material with a free π-electron system, such as PEEK material with benzene rings. This creates an electrically conductive connection between the graphite particles via the π-electron system of the matrix material without needing to use conductive carbon black. This allows the production process to be advantageously influenced by injection molding, wherein a relatively low fill level of the conductive additional component can be selected compared to an additional component comprising conductive carbon black. This allows the production parameters injection pressure, injection time and holding pressure during the injection process to be advantageously selected with good flowability in the cavity 31. In addition, two preferred directions of the graphite layers are formed in the molding mass during the injection molding process. In the region near the wall, the graphite particles are preferably oriented in the flow direction, while in the core zone they are primarily oriented perpendicular to the flow direction. This results in a favorable influence on the electrical conductivity for the function of the flat fuel cell component, such as the bipolar plate.

It is also advantageous to select the particle size or the D₅₀ values of the additional component that describe it in the range between 5 μm and 50 μm or 100 μm, for example between 10 μm and 30 μm, wherein it is also possible to adjust them to the selected thickness of the flat fuel cell component. It is also advantageous to select graphite particles with a low aspect ratio (thickness to smallest dimension at right angles thereto), i.e. platelet-shaped graphite particles with the greatest possible planar extent, with an aspect ratio of less than 5, in particular less than 1 or 0.5, being advantageous. The fill level of the graphite particles can be in the range between 5 vol. % and 95 vol. %, for example between 20 vol. % and 80 vol. % or optionally also between 5 wt. % and 95 wt. % or between 20 wt. % and 87 wt. % or 80 wt. %, based on the raw material.

1. Method for producing flat fuel cell components (6), in particular bipolar plates, from thermoplastic material with an additional component that has good electrical and thermal conductivity, wherein the flat fuel cell component is produced by means of injection molding using an injection molding device (1) which has at least one injection unit (2) and at least one mold unit (3) with a wall surrounding a respective cavity,
characterized in that
the melted thermoplastic material with the additional component is filled as melt mass by means of the at least one injection unit (2) under pressure into the hollow space of the respective cavity (31) of the at least one mold unit (3), said hollow space corresponding unchanged to the geometry of the fuel cell component, and the heat transfer via the wall (30) is adapted to the thermal conductivity and thermal capacity and filling speed of the melt mass in such a manner that the respective cavity (31) is completely filled with this as molding mass (5) before the temperature of the melt mass falls below its melting temperature.

2. Method according to claim 1,
characterized in that
graphite is added to the thermoplastic material as a modifying electrically conductive additional component without or with the addition of a small amount of carbon black in a mass fraction of the additional component greater than 5%, greater than 20% or greater than 30%, preferably greater than 50%, for example between 5% and 95%, in particular between 30% and 70% or 87% of the total mass of a raw material fed to the injection unit (2).

3. Method according to claim 1 or 2,
characterized in that
a polymer material with a free Π-electron system, in particular a PEEK material, is used as the thermoplastic material forming the matrix material of the flat fuel cell component, and in that
only graphite particles, in particular with an aspect ratio of thickness to smallest dimension of less than 5, in particular less than 1 or 0.5, are used as the conductive additional component.

4. Method according to claim 1 or 2,
characterized in that
the flat fuel cell component (6) is produced with a thickness (d) perpendicular to its planar extent in plan view of at most 2 mm, at most 1 mm or at most 0.5 mm or at most 0.2 mm.

5. Method according to any of the preceding claims,
characterized in that
the particles of the conductive additional component have a size D₅₀ in the range of 5 μm to 50 μm or 100 μm.

6. Method according to any of the preceding claims,
characterized in that
the fuel component (6) is provided with at least one connection element, fastening element, line element and/or sealing element by molding and/or injection molding in the injection process.

7. Flat fuel cell component (6), in particular a bipolar plate,
characterized in that
it is produced using the method according to any of the preceding claims.

8. Injection molding device for carrying out the method according to any of claims 1 to 6, comprising at least one injection unit (2) for feeding a raw material (4) with thermoplastic material and with an electrically conductive additional component, in particular comprising graphite particles, and comprising at least one mold unit, which has a nozzle-side mold portion (3′) assigned to at least one injection nozzle arrangement and an ejector-side mold portion (3″) assigned to an ejector side, which are arranged in a mold part receptacle (35), face one another in a parting plane and each comprise a part of a respective mold part with a mold insert (32) and a mold core (33), wherein a respective cavity (31) is formed in the mold insert (32), which cavity can be opened in the parting plane and is closed during an injection process and which is connected via a feed unit (24) with a hot runner system or cold runner system to the injection unit (2) for injecting the melted raw material (4) as a melt mass into the hollow space of the cavity (31),
characterized in that
the geometry of the hollow space of the respective cavity (31) with the inner surface of the mold insert (32) surrounding it is adapted unchanged to the geometry of the fuel component to be produced during the molding process until the at least one mold unit (3) is opened.

9. Injection molding device according to claim 8,
characterized in that
tempering means (7) are arranged between the mold insert (32) and the mold core (33) in the nozzle-side and/or the ejector-side mold portion (3′, 3″).

10. Injection molding device according to claim 9,
characterized in that
the tempering means (7) comprise heating means (70) and/or cooling means (71).

11. Injection molding device according to claim 10,
characterized in that
the heating means (70) can be heated by means of current heat via electrical conduction means, inductively or by means of a heat transfer fluid guided through channels, and/or in that
the cooling means (71) can be cooled by means of a cooling fluid conducted via channels or are provided with an electrically operated cooling device.

12. Injection molding device according to any of claims 8 to 11,
characterized in that
at least the mold insert (32) consists of a material with good thermal conductivity, in particular metal or ceramic, and in that
at least the mold part comprising the mold insert (32) and the mold core (33) is enclosed by heat-insulating insulating parts (34).
